(19) United States
(12) Patent Application Publication
(10) Pub. No.: US 2025/0309961 A1
(43) Pub. Date: Oct. 2, 2025

(54) CHANNEL STATE INFORMATION REPORT IN LOW POWER WAKE-UP SIGNAL PROCEDURE

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Igor GUTMAN, Hod HaSharon (IL); Hemant SAGGAR, San Diego, CA (US); Jelena DAMNJANOVIC, Del Mar, CA (US)

(21) Appl. No.: 19/041,123

(22) Filed: Jan. 30, 2025

Related U.S. Application Data
(60) Provisional application No. 63/572,801, filed on Apr. 1, 2024.

(51) Int. Cl. H04B 7/06; H04W 24/10; H04W 52/02; H04W 76/28

(52) U.S. Cl. CPC H04B 7/0626; H04W 24/10; H04W 52/0235; H04W 76/28

(57) ABSTRACT

Methods, systems, and devices for wireless communication are described. A user equipment (UE) may receive control signaling indicating a channel state information (CSI) reporting configuration, the CSI reporting configuration indicating a set of reporting occasions, where the set of reporting occasions may include a first reporting occasion scheduled for transmission of a CSI report. The UE may select a second reporting occasion of the set of reporting occasions for transmission of the CSI report, the second reporting occasion occurring after the first reporting occasion and selected as a replacement to transmission of the CSI report via the first reporting occasion. For example, the second reporting occasion may be selected based on a low power-wake-up signal (LP-WUS) configuration indicated to the UE. The UE may transmit the CSI report via the second reporting occasion.

### RELATED APPLICATIONS

The present Application for Patent claims the benefit of Provisional Patent Application No. 63/572,801 by RYU et al., entitled “CHANNEL STATE INFORMATION REPORT IN LOW POWER WAKE-UP SIGNAL PROCEDURE,” filed Apr. 1, 2024, assigned to the assignee hereof and hereby expressly incorporated by reference herein.

### FIELD OF TECHNOLOGY

The following relates to wireless communication, including channel state information reporting in low power wake-up signal scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, a UE may transmit channel state information (CSI) reports to a network entity, which may contain an indication of one or more measurements performed by the UE associated with a channel of the UE.

### SUMMARY

The described techniques relate to improved methods, systems, devices, and apparatuses that support channel state information report in low power wake-up signal (LP-WUS) scenarios. For example, the described techniques provide for a user equipment (UE) to be configured with techniques to reduce the frequency of transmitting channel state information (CSI) reports, which may reduce the use of a main radio of the UE and thereby achieve power savings for the UE while operating using LP-WUS techniques. In some examples, the UE may be configured with a longer reporting period, which may reduce the frequency of CSI reports. Additionally, or alternatively, the UE may be configured to transmit CSI reports on a reporting occasion when a condition is (e.g., or is not) satisfied, and the UE may otherwise skip the reporting occasion. For example, the UE may be configured to (e.g., always) transmit a CSI report on a subset of reporting occasions (e.g., every other occasion, every third occasion), and the UE may skip transmitting a CSI report via other reporting occasions based on whether one or more conditions are satisfied. Additionally, or alternatively, the UE may transmit CSI reports after receiving a wake-up signal. For example, the UE may transmit a CSI report on a reporting occasion that overlaps with an ON duration corresponding to the received wake-up signal. Additionally, or alternatively, the UE may transmit the CSI report based on receiving a reference signal prior to the reporting occasion (e.g., at least a threshold duration prior). Accordingly, the UE may reduce the frequency of transmitting CSI reports, which may increase energy savings by the UE while operating using LP-WUS techniques, for example.

A method for wireless communications by a UE is described. The method may include receiving control signaling indicating a CSI reporting configuration, the CSI reporting configuration indicating a set of reporting occasions, where the set of reporting occasions includes a first reporting occasion scheduled for transmission of a CSI report, selecting a second reporting occasion of the set of reporting occasions for transmission of the CSI report, the second reporting occasion occurring after the first reporting occasion and selected as a replacement to transmission of the CSI report via the first reporting occasion, and transmitting the CSI report via the second reporting occasion.

A UE for wireless communications is described. The UE may include one or more memories storing processor executable code, and one or more processors coupled with the one or more memories. The one or more processors may individually or collectively be operable to execute the code to cause the UE to receive control signaling indicating a CSI reporting configuration, the CSI reporting configuration indicating a set of reporting occasions, where the set of reporting occasions includes a first reporting occasion scheduled for transmission of a CSI report, select a second reporting occasion of the set of reporting occasions for transmission of the CSI report, the second reporting occasion occurring after the first reporting occasion and selected as a replacement to transmission of the CSI report via the first reporting occasion, and transmit the CSI report via the second reporting occasion.

Another UE for wireless communications is described. The UE may include means for receiving control signaling indicating a CSI reporting configuration, the CSI reporting configuration indicating a set of reporting occasions, where the set of reporting occasions includes a first reporting occasion scheduled for transmission of a CSI report, means for selecting a second reporting occasion of the set of reporting occasions for transmission of the CSI report, the second reporting occasion occurring after the first reporting occasion and selected as a replacement to transmission of the CSI report via the first reporting occasion, and means for transmitting the CSI report via the second reporting occasion.

A non-transitory computer-readable medium storing code for wireless communications is described. The code may include instructions executable by one or more processors to receive control signaling indicating a CSI reporting configuration, the CSI reporting configuration indicating a set of reporting occasions, where the set of reporting occasions includes a first reporting occasion scheduled for transmission of a CSI report, select a second reporting occasion of the set of reporting occasions for transmission of the CSI report, the second reporting occasion occurring after the first reporting occasion and selected as a replacement to transmission of the CSI report via the first reporting occasion, and transmit the CSI report via the second reporting occasion.

Some examples of the method, UEs, and non-transitory computer-readable medium described herein may further include operations, features, means, or instructions for receiving an LP-WUS configuration associated with transmission of a wake up signal to trigger monitoring of downlink control signaling, where the second reporting occasion may be selected based on receiving the LP-WUS configuration.

In some examples of the method, UEs, and non-transitory computer-readable medium described herein, the set of reporting occasions may be associated with a first reporting period and the method, apparatuses, and non-transitory computer-readable medium may include further operations, features, means, or instructions for selecting the second reporting occasion in accordance with a second reporting period that may be longer than the first reporting period based on receiving the LP-WUS configuration.

Some examples of the method, UEs, and non-transitory computer-readable medium described herein may further include operations, features, means, or instructions for selecting the second reporting occasion based on one or more conditions failing to be satisfied.

In some examples of the method, UEs, and non-transitory computer-readable medium described herein, the one or more conditions include a reference signal received power associated with one or more beams indicated in a previous CSI report transmitted by the UE falling below a threshold value, a reference signal received power associated with a current beam of the UE falling below a threshold value, or both.

Some examples of the method, UEs, and non-transitory computer-readable medium described herein may further include operations, features, means, or instructions for receiving an indication of a subset of the set of reporting occasions for transmission of a respective CSI report, the subset including at least the second reporting occasion, where selecting the second reporting occasion may be based on receiving the indication of the subset and the LP-WUS configuration.

In some examples of the method, UEs, and non-transitory computer-readable medium described herein, the subset of the set of reporting occasions includes every other reporting occasion of the set of reporting occasions.

Some examples of the method, UEs, and non-transitory computer-readable medium described herein may further include operations, features, means, or instructions for transmitting a second CSI report via a third reporting occasion of the set of reporting occasions, the third reporting occasion absent from the subset, based on one or more conditions being satisfied.

In some examples of the method, UEs, and non-transitory computer-readable medium described herein, the one or more conditions include a reference signal received power associated with one or more beams indicated in a previous CSI report transmitted by the UE falling below a threshold value, a reference signal received power associated with a current beam of the UE falling below a threshold value, or both.

Some examples of the method, UEs, and non-transitory computer-readable medium described herein may further include operations, features, means, or instructions for receiving a wake up signal based on the received LP-WUS configuration and selecting the second reporting occasion based on the second reporting occasion overlapping with an ON duration corresponding to the received wake up signal.

Some examples of the method, UEs, and non-transitory computer-readable medium described herein may further include operations, features, means, or instructions for receiving a reference signal after receiving the wake up signal and prior to the second reporting occasion, where transmitting the CSI report via the second reporting occasion may be based on receiving the reference signal.

Some examples of the method, UEs, and non-transitory computer-readable medium described herein may further include operations, features, means, or instructions for transmitting the CSI report may be based on receiving the reference signal at least a threshold duration prior to the second reporting occasion.

Some examples of the method, UEs, and non-transitory computer-readable medium described herein may further include operations, features, means, or instructions for selecting the second reporting occasion based on a reference signal received power associated with one or more beams indicated in a previous CSI report transmitted by the UE being above a threshold value, a reference signal received power associated with a current beam of the UE being above a threshold value, or both.

Some examples of the method, UEs, and non-transitory computer-readable medium described herein may further include operations, features, means, or instructions for receiving an indication of a subset of the set of reporting occasions for transmission of a respective CSI report, the subset including at least the second reporting occasion, where selecting the second reporting occasion may be based on receiving the indication of the subset.

In some examples of the method, UEs, and non-transitory computer-readable medium described herein, the subset of the set of reporting occasions includes every other reporting occasion of the set of reporting occasions.

Some examples of the method, UEs, and non-transitory computer-readable medium described herein may further include operations, features, means, or instructions for transmitting a second CSI report via a third reporting occasion of the set of reporting occasions, the third reporting occasion absent from the subset, based on one or more conditions being satisfied.

In some examples of the method, UEs, and non-transitory computer-readable medium described herein, the one or more conditions include a reference signal received power associated with one or more beams indicated in a previous CSI report transmitted by the UE falling below a threshold value, a reference signal received power associated with a current beam of the UE falling below a threshold value, or both.

Some examples of the method, UEs, and non-transitory computer-readable medium described herein may further include operations, features, means, or instructions for selecting the second reporting occasion may be based on a reference signal being received at least a threshold duration prior to the second reporting occasion.

### BRIEF DESCRIPTION OF THE DRAWINGS

FIG. 1 shows an example of a wireless communications system that supports channel state information reporting in low power wake-up signal (LP-WUS) scenarios in accordance with one or more aspects of the present disclosure.

FIG. 2 shows an example of a wireless communications system that supports channel state information reporting in LP-WUS scenarios in accordance with one or more aspects of the present disclosure.

FIG. 3 and FIG. 4 show examples of signaling diagrams that support channel state information reporting in LP-WUS scenarios in accordance with one or more aspects of the present disclosure.

FIG. 5 shows an example of a process flow that supports channel state information reporting in LP-WUS scenarios in accordance with one or more aspects of the present disclosure.

FIGS. 6 and 7 show block diagrams of devices that support channel state information reporting in LP-WUS scenarios in accordance with one or more aspects of the present disclosure.

FIG. 8 shows a block diagram of a communications manager that supports channel state information reporting in LP-WUS scenarios in accordance with one or more aspects of the present disclosure.

FIG. 9 shows a diagram of a system including a device that supports channel state information reporting in LP-WUS scenarios in accordance with one or more aspects of the present disclosure.

FIGS. 10 and 11 show flowcharts illustrating methods that support channel state information reporting in LP-WUS scenarios in accordance with one or more aspects of the present disclosure.

### DETAILED DESCRIPTION

In some examples, to reduce power consumption at a user equipment (UE), the UE may be configured to operate using low power wake-up signal (LP-WUS) techniques. For example, the UE may receive a wake-up signal (e.g., an LP-WUS), which may trigger the UE to monitor for downlink control signaling from a network entity during a configured occasion (e.g., an ON duration). As such, the UE may stay in a sleep mode for longer periods if the UE does not receive a wake-up signal, thereby saving power at the UE. In some cases, the UE may be equipped with a low power-wake-up radio (LP-WUR) for receiving wake-up signals. The LP-WUR of the UE may be associated with lower power consumption relative to a main radio (e.g., transceiver) of the UE, and the UE may reduce power consumption while receiving wake-up signals as the UE may maintain the main radio in an off state. However, the UE may still be configured to transmit channel state information (CSI) reports, and the UE may not be able to transmit CSI reports using the LP-WUR. As such, the UE may switch to using the main radio to transmit CSI periodic reports, which may increase power consumption despite the UE being configured with the LP-WUS techniques. Accordingly, techniques to decrease energy consumption while performing CSI reporting may be desired.

In accordance with examples as described herein, a UE may be configured with techniques to reduce the frequency of transmitting CSI reports, which may reduce the use of the main radio and thereby achieve power savings for the UE while operating using LP-WUS techniques. In some examples, the UE may be configured with a longer reporting period, which may reduce the frequency of CSI reports. Additionally, or alternatively, the UE may be configured to transmit CSI reports on a reporting occasion when a condition is (e.g., or is not) satisfied, and the UE may otherwise skip the reporting occasion. In some cases, the UE may be configured to (e.g., always) transmit a CSI report on a subset of reporting occasions (e.g., every other occasion, every third occasion), and the UE may skip transmitting a CSI report via other reporting occasions based on whether one or more conditions are satisfied. In some examples, the UE may transmit CSI reports after receiving a wake-up signal. For example, the UE may transmit a CSI report on a reporting occasion that overlaps with an ON duration corresponding to the received wake-up signal. Additionally, or alternatively, the UE may transmit the CSI report based on receiving a reference signal prior to the reporting occasion (e.g., at least a threshold duration prior).

Particular aspects of the subject matter described in this disclosure can be implemented to realize one or more of the following potential advantages. In some examples, by implementing the techniques described herein, the UE may reduce the frequency of transmitting CSI reports. The reduced frequency of CSI reports may lead to increased energy savings by the UE, especially while operating using LP-WUS techniques, for example. The reduced power consumption may decrease processing at the UE and extend battery life, which may improve the user experience. Additionally, or alternatively, these techniques may improve device and battery durability over the lifespan of the device.

Aspects of the disclosure are initially described in the context of wireless communications systems. Aspects of the disclosure are additionally illustrated in the context of signaling diagrams and process flows relating to reducing power consumption associated with CSI reporting. Aspects of the disclosure are further illustrated by and described with reference to apparatus diagrams, system diagrams, and flowcharts that relate to channel state information reporting in LP-WUS scenarios.

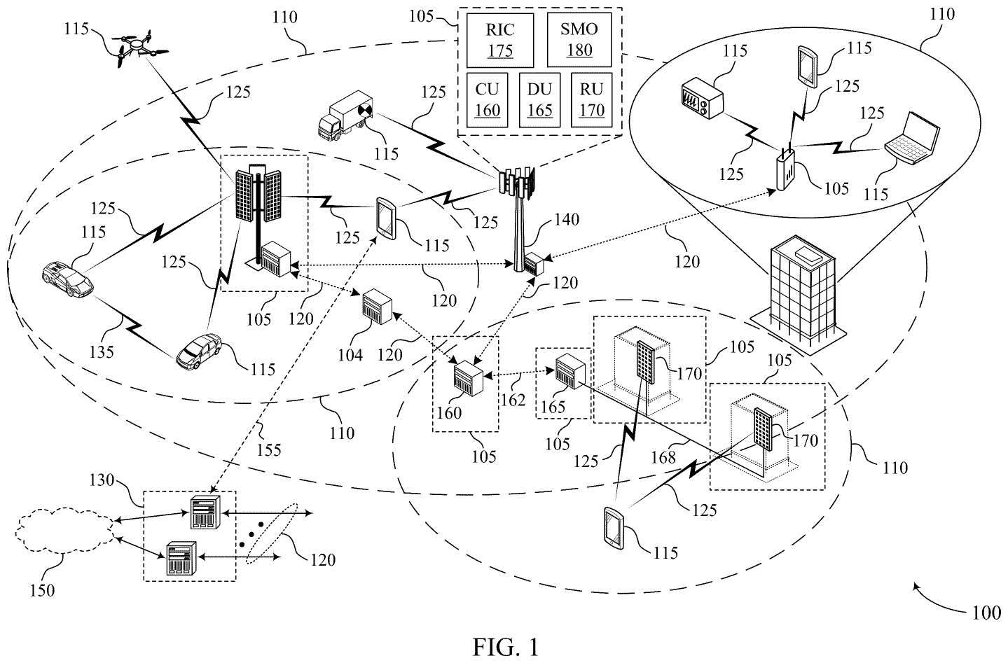

FIG. 1 shows an example of a wireless communications system 100 that supports channel state information reporting in LP-WUS scenarios in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, to reduce power consumption at a UE 115, the UE 115 may be configured to operate using discontinuous reception techniques (DRX). For example, the UE 115 may monitor of downlink control signaling form a network entity 105 during a DRX active time, and the UE 115 may avoid monitoring for downlink signaling during a DRX inactive time and may enter a sleep mode to save power. However, the UE 115 may still monitor for synchronization signals (e.g., reference signals) from the network entity 105. As such, it may be beneficial to keep a receiver of the UE (e.g., a main radio) on during the sleep state, as switching the receiver on and off consumes a significant amount of power.

To increase power savings at the UE 115, the UE 115 may operate using LP-WUS techniques, as described herein. In some examples, the UE 115 may be equipped with an LP-WUR, which may be used to receive low power synchronization signals, LP-WUSs, low power reference signals, or other signaling while the UE 115 is in a sleep state. The LP-WUR may be associated with lower power consumption when switching the LP-WUR on or off, thereby allowing the UE 115 to keep the LP-WUR in the off state for longer periods of time, for example, when the UE 115 does not expect to receive synchronization signals, reference signals, or wake-up signals. Additionally, or alternatively, the UE 115 may maintain a main radio (e.g., main receiver) of the UE 115 in an off state for longer periods of time, thereby reducing power consumption. For example, the UE 115 may bet triggered to switch the main radio on when the UE 115 receives a wake-up signal (e.g., an LP-WUS) to monitor for downlink signaling (e.g., downlink control signaling via a physical downlink control channel) from the network entity 105.

The UE 115 may be configured to transmit CSI reports to the network entity 105 periodically, however. Since the LP-WUR may be configured as a receiver (e.g., and not a transceiver), the UE 115 may not be able to transmit CSI reports using the LP-WUR. As such, the UE 115 may switch on the main radio to transmit the periodic CSI reports. This may increase power consumption at the UE 115, as the UE 115 may enable the main radio to transmit the CSI reports despite being configured with the LP-WUS techniques. Accordingly, techniques to decrease energy consumption while performing CSI reporting may be desired.

In accordance with examples as described herein, a UE 115 may be configured with techniques to reduce the frequency of transmitting CSI reports, which may reduce the use of the main radio and thereby achieve power savings for the UE 115 while operating using LP-WUS techniques. In some examples, the UE may be configured with a longer reporting period, which may reduce the frequency of CSI reports. Additionally, or alternatively, the UE 115 may be configured to transmit CSI reports on a reporting occasion when a condition is (e.g., or is not) satisfied, and the UE 115 may otherwise skip the reporting occasion. In some cases, the UE 115 may be configured to transmit a CSI report on a subset of reporting occasions (e.g., every other occasion, every third occasion), and the UE 115 may skip transmitting a CSI report via other reporting occasions altogether, or based on whether one or more conditions are satisfied. In some examples, the UE 115 may transmit CSI reports after receiving a wake-up signal. For example, the UE 115 may transmit a CSI report on a reporting occasion that overlaps with an ON duration corresponding to the received wake-up signal. Additionally, or alternatively, the UE 115 may transmit the CSI report based on receiving a reference signal prior to the reporting occasion (e.g., at least a threshold duration prior). Accordingly, the UE 115 may reduce the frequency of transmitting CSI reports, which may increase energy savings by the UE 115 while operating using LP-WUS techniques, for example.

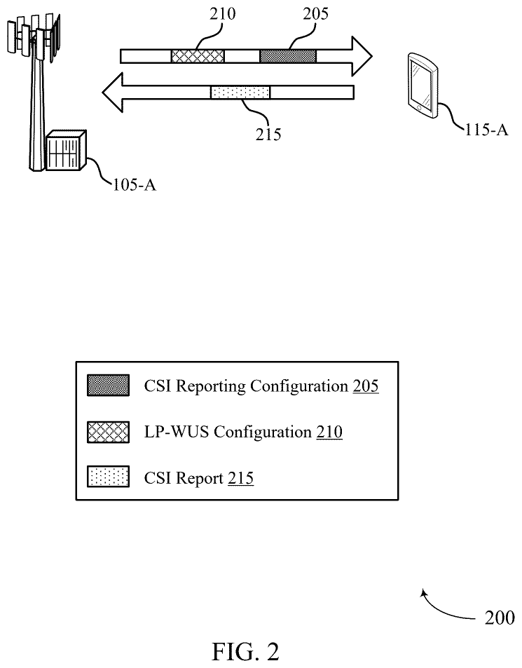

FIG. 2 shows an example of a wireless communications system 200 that supports channel state information reporting in LP-WUS scenarios in accordance with one or more aspects of the present disclosure. The wireless communications system illustrates communications between a UE 115-a and a network entity 105-a, which may be examples of corresponding devices as described herein, with reference to FIG. 1.

In some examples, the UE 115-a may be configured to transmit CSI reports 215 to the network entity 105-a. A CSI report 215 may include an indication of measurements performed by the UE 115-a of a channel between the network entity 105-a and the UE 115-a. The indication of the measurements, as measured by the UE 115-a, may include a channel quality indicator (CQI), a precoding matrix indicator (PMI), a rank indicator (RI), a CSI reference signal reference indicator (CRI), an SSB reference indicator (SSBRI), or a combination thereof. The measurements may be performed by the UE 115-a based on received reference signals, such as via an SSB or a CSI reference signal. The measurements may be associated with one or more beams of the network entity 105-a or the UE 115-a, and the CSI report 215 may include beam management measurements (e.g., reports). In some cases, the CSI report 215 may include an indication of a Layer 1 signal-to-interference-and-noise ratio (L1-SINR) or a Layer 1 reference-signal-received-power (L1-RSRP) corresponding to measured reference signals.

In some examples, CSI reports 215 may be periodic, aperiodic, or semi-persistent. For example, the network entity 105-a may transmit signaling indicating a CSI reporting configuration 205 to the UE 115-a. The CSI reporting configuration 205 may indicate a set of reporting occasions, and the UE 115-a may be configured to transmit a CSI report 215 via each reporting occasion.

In some cases, the UE 115-a may be configured with LP-WUS techniques to reduce power consumption at the UE 115-a, as described herein. For example, the UE 115-a may be equipped with an LP-WUR, which may be used to receive low power signaling (e.g., wake-up signals, reference signals, synchronization signals), in addition to a main radio of the UE 115-a. The UE 115-a may receive a LP-WUS configuration 210 from the network entity 105-a, which may enable the UE 115-a to operate using the LP-WUS techniques and the LP-WUR. However, the UE 115-a may use the main radio to transmit CSI reports 215, as the LP-WUR may be configured as a receiver and may be unable to transmit the CSI reports 215. As such, the UE 115-a may periodically switch the main radio on and off to transmit CSI reports 215, which may increase power consumption despite the UE 115-a being configured with LP-WUS techniques. Accordingly, techniques to reduce the power consumption associated with transmitting CSI reports 215 may be desired.

In accordance with examples as described herein, the UE 115-a may be configured to reduce the periodicity of CSI reports 215. In some examples, the CSI reporting configuration 205 may configure the UE 115-a with a longer period between reporting occasions for CSI reports 215. In some cases, the longer period between reporting occasions may be based on the UE 115-a operating using LP-WUS techniques. For example, the UE 115-a may select the longer period based on receiving the LP-WUS configuration 210. For instance, the UE 115-a may select one or more occasions of the set of occasions indicated in the CSI reporting configuration 205 via which to transmit CSI reports 215, and select one or more occasions to skip transmitting CSI reports 215 based on receiving the LP-WUS configuration 210.

Additionally, or alternatively, the network entity 105-a may transmit a CSI reporting configuration 205 with a longer reporting period based on configuring the UE 115-a to operate using LP-WUS techniques (e.g., based on or after transmitting the LP-WUS configuration 210). In some examples, the CSI reporting configuration 205 may indicate a first reporting period associated with a first set of reporting occasions and a second reporting period associated with a second set of reporting occasions, where the second reporting period corresponds to a longer period between reporting occasions. The UE 115-a may be configured (e.g., via the CSI reporting configuration 205, via the LP-WUS configuration 210) to select the second reporting period when LP-WUS techniques are enabled. Additionally, or alternatively, the LP-WUS configuration 210 may indicate the second reporting period. As such, the UE 115-a may maintain the main radio of the UE 115-a in an off state for longer periods while operating using the LP-WUR, thereby improving power savings.

In some examples, the UE 115-a may be configured (e.g., via the CSI reporting configuration 205, the LP-WUS configuration 210, or otherwise configured) to transmit a CSI report 215 via a reporting occasion indicated in the CSI reporting configuration 205 based on one or more conditions being satisfied. If the one or more conditions are not satisfied, the UE 115-a may skip the reporting occasion. In some examples, the one or more conditions may include whether one or more beams (e.g., a synchronization signal or physical broadcast channel resource block indicator (e.g., SSBRI), a CSI reference signal resource indicator (CRI)) indicated in a previously transmitted CSI report 215 (e.g., a last transmitted CSI report 215) has degraded, such as if a measured RSRP falls below a threshold value. Additionally, or alternatively, the one or more conditions may include whether a current beam used by the UE 115-a has degraded, such as if the RSRP associated with the current beam falls below a threshold value. In some cases, the threshold values to trigger the CSI report 215 may be configured to the UE 115-a by the network entity 105-a (e.g., via the LP-WUS configuration 210). For example, the UE 115-a may be configured to transmit CSI reports 215 based on the one or more conditions being satisfied if LP-WUS procedures are enabled at the UE 115-a (e.g., based on receiving the LP-WUS configuration 210).

Additionally, or alternatively, the UE 115-a may be configured to transmit a CSI report 215 in a subset of the set of reporting occasions configured by the CSI reporting configuration 205. For example, the UE 115-a may be configured to (e.g., always) transmit CSI reports 215 in the subset of the set of reporting occasions, and the UE 115-a may transmit CSI reports 215 in reporting occasions outside of the subset based on one or more conditions being met. The one or more conditions may correspond to degradation of a previously reported beam or a current beam of the UE 115-a, as described herein. In some examples, the UE 115-a may be configured to transmit CSI reports 215 in the subset of the set of reporting occasions based on operating using LP-WUS techniques (e.g., based on receiving the LP-WUS configuration 210). For example, the LP-WUS configuration 210 may indicate the UE 115-a to transmit CSI reports 215 via every other occasion of the set of reporting occasions, via every third occasion, or via another fraction of the set of reporting occasions, and to optionally transmit CSI reports 215 on the remaining reporting occasions based on the one or more conditions being satisfied (e.g., or to refrain from transmitting CSI reports 215 on the remaining reporting occasions altogether). In some cases, the UE 115-a may transmit a CSI report 215 on a reporting occasion outside the subset if the UE 115 receives a wake-up signal, such as an LP-WUS.

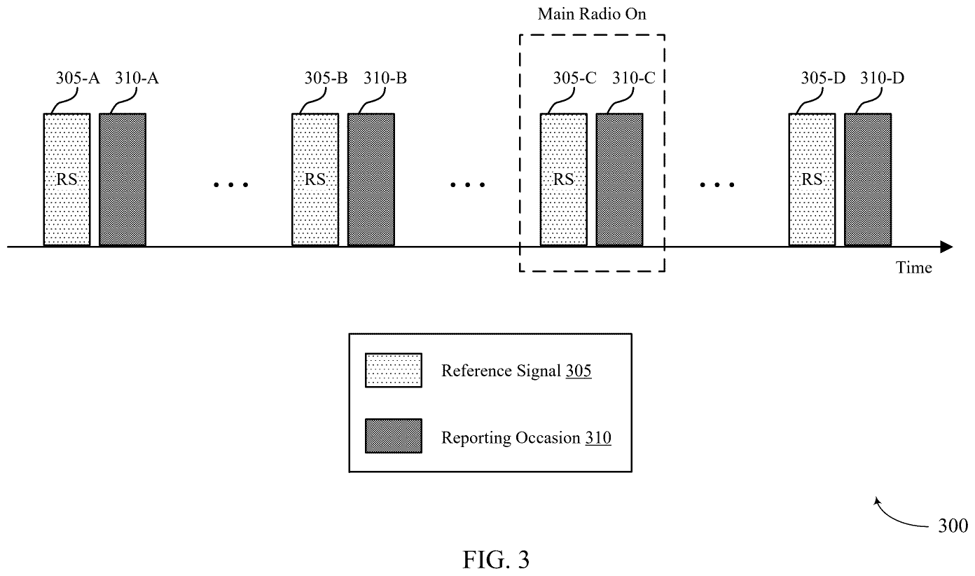

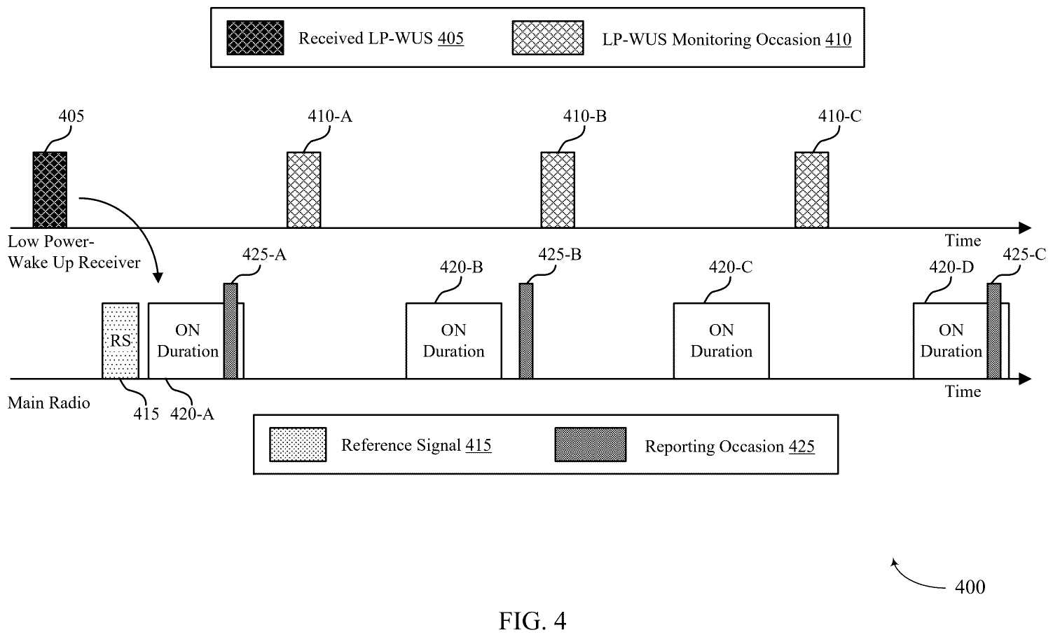

In some examples, the UE 115-a may be configured to transmit CSI reports 215 via reporting occasions that overlap with an ON duration configured for the UE 115-a. For example, the UE 115-a may be configured to operate in connected mode DRX, in which a wake-up signal (e.g., an LP-WUS) may trigger the UE 115-a to monitor for downlink control signaling via an ON duration associated with the wake-up signal. The UE 115-a may be configured to transmit a CSI report 215 via reporting occasions configured via the CSI reporting configuration 205 that overlap with an ON duration corresponding to a wake-up signal. Additionally, or alternatively, the UE 115-a may transmit the CSI report 215 if the corresponding wake-up signal is received prior to the ON duration. These examples regarding transmission of CSI reports 215 are described in more detail herein, with reference to FIGS. 3 and 4.

In some cases, the UE 115-a may receive a configuration that may enable or disable the skipping of CSI reporting occasions, beam management (BM) measurement reporting, or both, during occasions where the UE 115-a is not configured to monitor for downlink control signaling. For example, the UE 115-a may receive an RRC configuration that enables or disables the skipping of CSI reporting occasions. In some cases, the enabling of CSI report skipping may be configured for periodic CSI reports 215, periodic L1-RSRP reporting, periodic L1-SINR reporting, or a combination thereof.

FIG. 3 shows an example of a signaling diagram 300 that supports channel state information reporting in LP-WUS scenarios in accordance with one or more aspects of the present disclosure. The signaling diagram 300 illustrates signaling of reference signals 305, such as a reference signal 305-a, a reference signal 305-b, a reference signal 305-c, and a reference signal 305-d, and reporting occasions 310 associated with transmission of CSI reports. The signaling diagram 300 may be implemented at a UE 115, as described herein with reference to FIGS. 1 and 2.

The UE 115 may be configured with a set of reporting occasions 310 via a CSI reporting configuration, which may include a reporting occasion 310-a, a reporting occasion 310-b, a reporting occasion 310-c, and a reporting occasion 310-d. As described herein, the UE 115 may be configured to reduce the reporting frequency of CSI reports to reduce power consumption at the UE 115. For example, the UE 115 may be configured (e.g., by a network entity 105) to transmit CSI reports via a subset of the reporting occasions 310, such as the reporting occasion 310-c. As such, the UE 115 may use a main radio of the UE 115 to transmit a CSI report during the reporting occasion 310-c. The UE 115 may receive (e.g., via the main radio) the reference signal 305-c, which may be an example of a frequency synchronization reference signal, to synchronize frequency with a transmitting network entity prior to transmitting the CSI report via the reporting occasion 310-c.

In some examples, the UE 115 may be configured to transmit via reporting occasions 310 other than the reporting occasion 310-c based on one or more conditions being satisfied, as described herein. For example, to determine whether the UE 115 is to transfer a CSI report via the reporting occasion 310-d, the UE 115 may determine whether a beam (e.g., a beam or index) reported in the CSI report transmitted via the reporting occasion 310-c has changed or degraded more than a threshold value. Additionally, or alternatively, the UE 115 may determine whether a current beam used by the UE 115 has degraded or changed more than the threshold value (e.g., or a different threshold value). If the one or more conditions are satisfied, the UE 115 may transmit a CSI report via the reporting occasion 310-d. Alternatively, if the one or more conditions are not satisfied, the UE 115-a may refrain from transmitting a CSI report via the reporting occasion 310-d. In some cases, the threshold value may be configurable, for example, via a LP-WUS configuration.

Accordingly, the UE 115 may refrain from transmitting CSI reports via one or more configured CSI reporting occasions, for example, if a beam or index associated with the UE 115 has not significantly changed, which may improve power savings at the UE 115.

FIG. 4 shows an example of a signaling diagram 400 that supports channel state information reporting in LP-WUS scenarios in accordance with one or more aspects of the present disclosure. The signaling diagram 400 may be implemented at a UE 115, as described herein with reference to FIGS. 1 through 3.

In some examples, the UE 115 may be configured with one or more LP-WUS monitoring occasions 410, such as the LP-WUS monitoring occasion 410-a, the LP-WUS monitoring occasion 410-b, and the LP-WUS monitoring occasion 410-c. The UE 115 may receive a LP-WUS 405 via a monitoring occasion 410. For example, if a network entity 105 has control signaling for transmission to the UE 115, the network entity 105 may transmit an LP-WUS 405 via a next LP-WUS monitoring occasion 410. In some examples, the UE 115 may monitor the LP-WUS monitoring occasions 410 using an LP-WUR, as described herein, which may be associated with lower power consumption relative to a main radio of the UE 115.

The UE 115 may also be configured with one or more ON durations 420, such as an ON duration 420-a, an ON duration 420-b, an ON duration 420-c, and an ON duration 420-d. The UE 115 may receive the downlink control signaling (e.g., a PDCCH) via an ON duration 420 if a corresponding LP-WUS 405 is received via a corresponding LP-WUS monitoring occasion 410 (e.g., prior to the ON duration 420). For example, the UE 115 may receive an LP-WUS 405 which may trigger the UE 115 to receive downlink control signaling via the ON duration 420-a. In some examples, the UE may receive a reference signal 415 (e.g., a synchronization signal, such as a frequency synchronization signal) from the network entity 105 prior to monitoring the ON duration 420-a.

As described herein, the UE 115 may be configured to transmit a CSI report (e.g., using the main radio) via a reporting occasion 425, such as the reporting occasion 425-a, the reporting occasion 425-b, and the reporting occasion 425-c. In some examples, the UE 115 may report CSI via a reporting occasion 425 if the reporting occasion overlaps with an ON duration 420. For example, the UE 115 may transmit a CSI report via the reporting occasion 425-a based on the reporting occasion 425-a overlapping with the ON duration 420-a. The UE 115 may refrain from transmitting a CSI report via the reporting occasion 425-b based on the reporting occasion 425-b not overlapping with any configured ON durations 420.

Additionally, or alternatively, the UE 115 may transmit a CSI report via a reporting occasion 425 that overlaps with an ON duration 420 based on receiving a corresponding LP-WUS 405. For example, the UE 115 may transmit the CSI report via the reporting occasion 425-a based on receiving the LP-WUS 405 corresponding to the ON duration 420-a. Conversely, the UE 115 may refrain from transmitting a CSI report via the reporting occasion 425-c, despite the reporting occasion 425-c overlapping with the ON duration 420-d, if an LP-WUS is not received via the LP-WUS monitoring occasion 410-c.

In some examples, the network entity 105 may be configured to transmit the reference signal 415 (e.g., a frequency synchronization reference signal, such as a CSI reference signal or a synchronization signal block (SSB)) prior to each reporting occasion 425-a, which may allow the UE to perform measurements and transmit the CSI report. In some cases, the UE 115 may transmit the CSI report based on reception of the reference signal 415 (e.g., a synchronization signal). For example, the UE 115 may transmit the CSI report via the reporting occasion 425-a based on receiving the reference signal 415 prior to the ON duration 420-a. In some cases, if the UE 115 does not receive (e.g., detect) the reference signal 415 at least a threshold duration prior to the reporting occasion 425-a, the UE 115 may refrain from transmitting the CSI report via the reporting occasion 425-a despite reception of the LP-WUS 405 and the reporting occasion 425-a overlapping with the ON duration 420-a. In some examples, the threshold duration may be configured to the UE 115, such as by the network entity 105 via an LP-WUS configuration.

Accordingly, the UE 115 may selectively transmit CSI reports via reporting occasions 425 due to one or more conditions being satisfied, which may reduce the time that the main radio of the UE 115 is being used, thereby reducing power consumption.

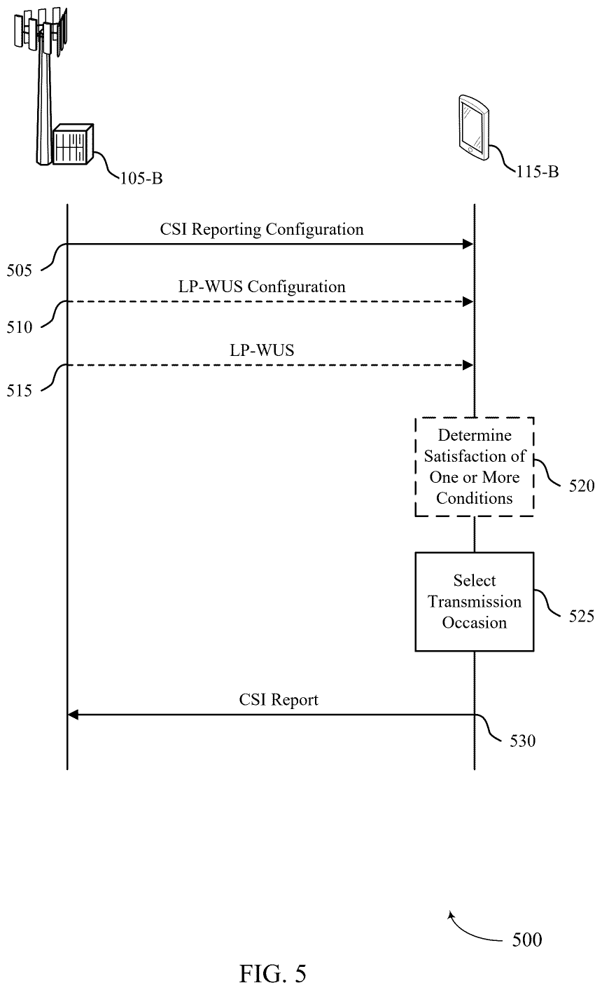

FIG. 5 shows an example of a process flow 500 that supports channel state information reporting in LP-WUS scenarios in accordance with one or more aspects of the present disclosure. The process flow 500 illustrates communications between a UE 115-b and a network entity 105-b, which may be examples of corresponding devices as described herein. The steps of the process flow 500 may be performed in different order than as shown, in some cases. Additionally, or alternatively, some steps may be added or omitted from the process flow 500.

At 505, the network entity 105-b may transmit control signaling indicating a CSI reporting configuration, the CSI reporting configuration indicating a set of reporting occasions, wherein the set of reporting occasions comprises a first reporting occasion scheduled for transmission of a CSI report by the UE 115-a.

At 510, the network entity 105-b may transmit an LP-WUS configuration associated with transmission of a wake-up signal (e.g., an LP-WUS) to trigger monitoring of downlink control signaling by the UE 115-b, as described herein. For example, the LP-WUS configuration may configure one or more LP-WUS monitoring occasions for the UE 115-b to monitor for a wake-up signal.

At 515, the network entity 105-b may transmit an LP-WUS to the UE 115-b. The LP-WUS may trigger the UE 115-a to monitor for downlink control signaling from the network entity 105-a using a main radio of the UE 115-b, for example, during an ON duration configured to the UE 115-b. In some cases, the UE 115-b may receive the LP-WUS via a LP-WUR equipped to the UE 115-b.

At 520, the UE 115-a may determine the satisfaction of one or more conditions. In some cases, the one or more conditions may include whether one or more beams reported by the UE 115-a in a previous CSI report, or one or more active (e.g., current) beams of the UE, have degraded (e.g., if a corresponding RSRP value is below a threshold value) or changed more than a threshold value. Additionally, or alternatively, the one or more conditions may include whether the first reporting occasion overlaps with an ON duration, whether the LP-WUS was received, whether a reference signal (e.g., a synchronization signal) was received at least a threshold duration prior to the first reporting occasion, or a combination thereof.

At 525, the UE 115-a may select a reporting occasion. In some examples, the UE 115-a may select a second reporting occasion of the set of reporting occasions as a replacement to the first reporting occasion for transmission of the CSI report. For example, the second reporting occasion may be selected based on the one or more conditions failing to be satisfied corresponding to the first reporting occasion. For instance, the current beams or the previously reported beams may not have degraded or changed more than a threshold value. Additionally, or alternatively, the first reporting occasion may not overlap with an ON duration, or the LP-WUS may not have been received by the UE 115-b.

In some examples, the UE 115-b may select a second reporting period that is longer (e.g., less frequent) than the first reporting period corresponding to the set of reporting occasions based on operating using LP-WUS techniques (e.g., based on receiving the LP-WUS configuration), and the UE 115-b may select the second reporting occasion that occurs after the first reporting occasion. Additionally, or alternatively, the UE 115-b may select a subset of the set of reporting occasions for transmitting CSI reports based on receiving the LP-WUS configuration, and the first reporting occasion may be absent (e.g., fall outside) the subset. As such, the UE 115-b may select the second reporting occasion based on the second reporting occasion being within the subset.

At 530, the UE 115-b may transmit the CSI report via the second reporting occasion. For example, the UE 115-b may transmit the CSI report via the second reporting occasion based on determining the satisfaction of the one or more conditions with relation to the second transmission occasion, as described herein.

Accordingly, the UE 115-b may be configured to reduce the frequency of CSI reports, such as when operating using LP-WUS procedures, which may reduce power consumption at the UE 115-b.

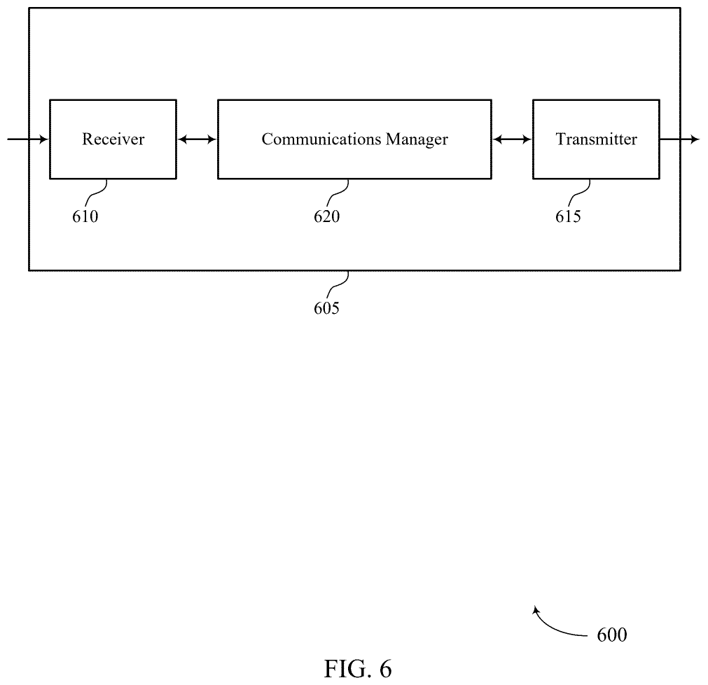

FIG. 6 shows a block diagram 600 of a device 605 that supports channel state information reporting in LP-WUS scenarios in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to channel state information reporting in LP-WUS scenarios). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel state information reporting in LP-WUS scenarios). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of channel state information reporting in LP-WUS scenarios as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling indicating a CSI reporting configuration, the CSI reporting configuration indicating a set of reporting occasions, where the set of reporting occasions includes a first reporting occasion scheduled for transmission of a CSI report. The communications manager 620 is capable of, configured to, or operable to support a means for selecting a second reporting occasion of the set of reporting occasions for transmission of the CSI report, the second reporting occasion occurring after the first reporting occasion and selected as a replacement to transmission of the CSI report via the first reporting occasion. The communications manager 620 is capable of, configured to, or operable to support a means for transmitting the CSI report via the second reporting occasion.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for transmission of CSI reports using reduced power consumption, such as when operating using LP-WUS techniques.

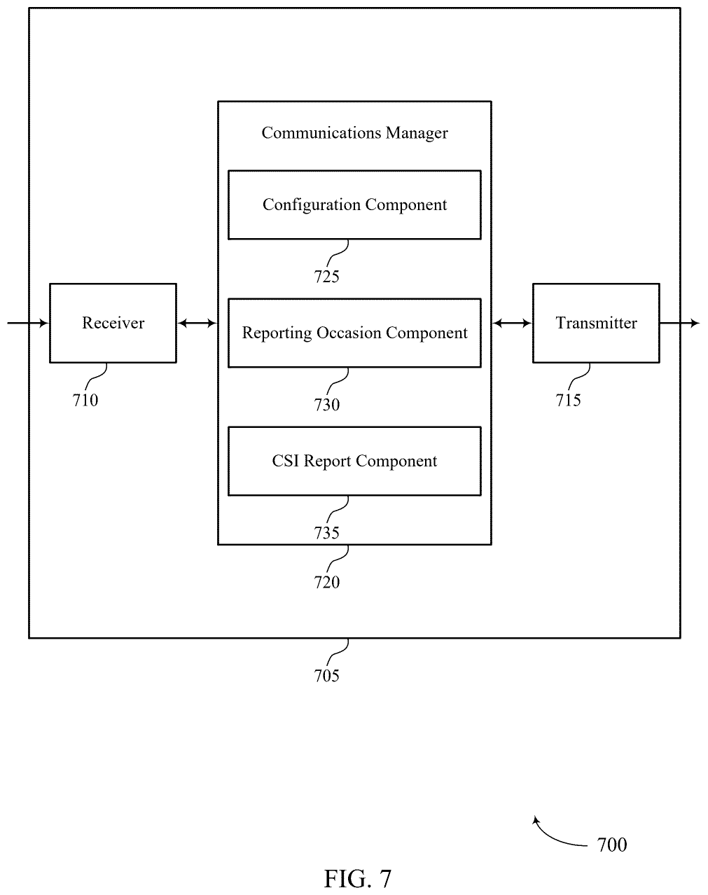

FIG. 7 shows a block diagram 700 of a device 705 that supports channel state information reporting in LP-WUS scenarios in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to channel state information reporting in LP-WUS scenarios). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel state information reporting in LP-WUS scenarios). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel state information reporting in LP-WUS scenarios as described herein. For example, the communications manager 720 may include a configuration component 725, a reporting occasion component 730, a CSI report component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving control signaling indicating a CSI reporting configuration, the CSI reporting configuration indicating a set of reporting occasions, where the set of reporting occasions includes a first reporting occasion scheduled for transmission of a CSI report. The reporting occasion component 730 is capable of, configured to, or operable to support a means for selecting a second reporting occasion of the set of reporting occasions for transmission of the CSI report, the second reporting occasion occurring after the first reporting occasion and selected as a replacement to transmission of the CSI report via the first reporting occasion. The CSI report component 735 is capable of, configured to, or operable to support a means for transmitting the CSI report via the second reporting occasion.

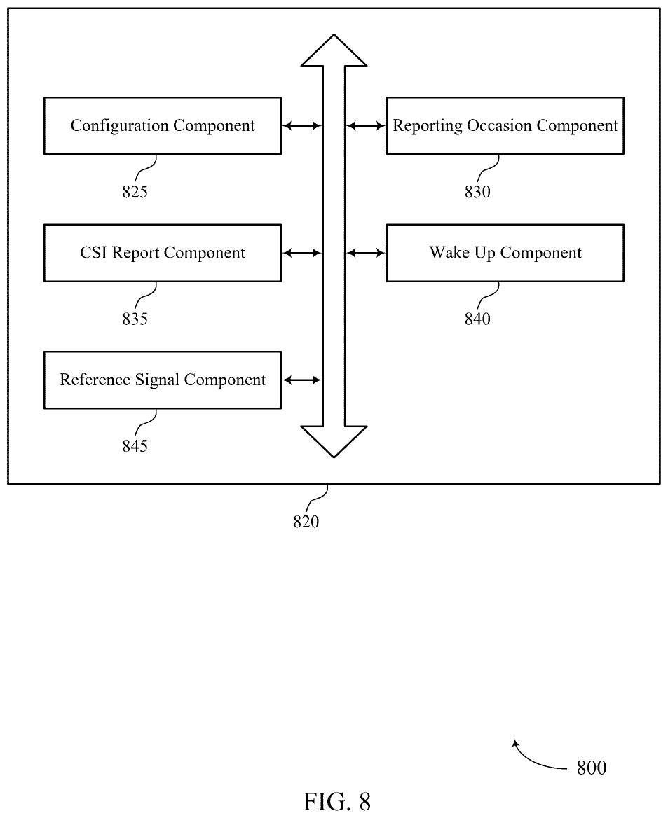

FIG. 8 shows a block diagram 800 of a communications manager 820 that supports channel state information reporting in LP-WUS scenarios in accordance with one or more aspects of the present disclosure. The communications manager 820 may be an example of aspects of a communications manager 620, a communications manager 720, or both, as described herein. The communications manager 820, or various components thereof, may be an example of means for performing various aspects of channel state information reporting in LP-WUS scenarios as described herein. For example, the communications manager 820 may include a configuration component 825, a reporting occasion component 830, a CSI report component 835, a wake-up component 840, a reference signal component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving control signaling indicating a CSI reporting configuration, the CSI reporting configuration indicating a set of reporting occasions, where the set of reporting occasions includes a first reporting occasion scheduled for transmission of a CSI report. The reporting occasion component 830 is capable of, configured to, or operable to support a means for selecting a second reporting occasion of the set of reporting occasions for transmission of the CSI report, the second reporting occasion occurring after the first reporting occasion and selected as a replacement to transmission of the CSI report via the first reporting occasion. The CSI report component 835 is capable of, configured to, or operable to support a means for transmitting the CSI report via the second reporting occasion.

In some examples, the wake-up component 840 is capable of, configured to, or operable to support a means for receiving a low power-wake-up signal (LP-WUS) configuration associated with transmission of a wake-up signal to trigger monitoring of downlink control signaling, where the second reporting occasion is selected based on receiving the LP-WUS configuration.

In some examples, the set of reporting occasions is associated with a first reporting period, and the reporting occasion component 830 is capable of, configured to, or operable to support a means for selecting the second reporting occasion in accordance with a second reporting period that is longer than the first reporting period based on receiving the LP-WUS configuration.

In some examples, the reporting occasion component 830 is capable of, configured to, or operable to support a means for selecting the second reporting occasion based on one or more conditions failing to be satisfied.

In some examples, the one or more conditions include a reference signal received power associated with one or more beams indicated in a previous CSI report transmitted by the UE falling below a threshold value, a reference signal received power associated with a current beam of the UE falling below a threshold value, or both.

In some examples, the reporting occasion component 830 is capable of, configured to, or operable to support a means for receiving (e.g., from a network entity), an indication of a subset of the set of reporting occasions for transmission of a respective CSI report, the subset including at least the second reporting occasion, where selecting the second reporting occasion is based on receiving the indication of the subset. In some examples, the subset of the set of reporting occasions includes every other reporting occasion of the set of reporting occasions.

In some examples, the CSI report component 835 is capable of, configured to, or operable to support a means for transmitting a second CSI report via a third reporting occasion of the set of reporting occasions, the third reporting occasion absent from the subset, based on one or more conditions being satisfied.

In some examples, the one or more conditions include a reference signal received power associated with one or more beams indicated in a previous CSI report transmitted by the UE falling below a threshold value, a reference signal received power associated with a current beam of the UE falling below a threshold value, or both.

In some examples, the wake-up component 840 is capable of, configured to, or operable to support a means for receiving a wake-up signal based on the received LP-WUS configuration. In some examples, the reporting occasion component 830 is capable of, configured to, or operable to support a means for selecting the second reporting occasion based on the second reporting occasion overlapping with an ON duration corresponding to the received wake-up signal.

In some examples, the reference signal component 845 is capable of, configured to, or operable to support a means for receiving a reference signal after receiving the wake-up signal and prior to the second reporting occasion, where transmitting the CSI report via the second reporting occasion is based on receiving the reference signal. In some examples, transmitting the CSI report is based on receiving the reference signal at least a threshold duration prior to the second reporting occasion.

In some examples, the reporting occasion component 830 is capable of, configured to, or operable to support a means for selecting the second reporting occasion based on a reference signal received power associated with one or more beams indicated in a previous CSI report transmitted by the UE being above a threshold value, a reference signal received power associated with a current beam of the UE being above a threshold value, or both.

In some examples, the reporting occasion component 830 is capable of, configured to, or operable to support a means for receiving (e.g., from the network entity) an indication of a subset of the set of reporting occasions for transmission of a respective CSI report, the subset including at least the second reporting occasion, where selecting the second reporting occasion is based on receiving the indication of the subset. In some examples, the subset of the set of reporting occasions includes every other reporting occasion of the set of reporting occasions.

In some examples, the CSI report component 835 is capable of, configured to, or operable to support a means for transmitting a second CSI report via a third reporting occasion of the set of reporting occasions, the third reporting occasion absent from the subset, based on one or more conditions being satisfied.

In some examples, the one or more conditions include a reference signal received power associated with one or more beams indicated in a previous CSI report transmitted by the UE falling below a threshold value, a reference signal received power associated with a current beam of the UE falling below a threshold value, or both. In some examples, selecting the second reporting occasion is based on a reference signal being received at least a threshold duration prior to the second reporting occasion.

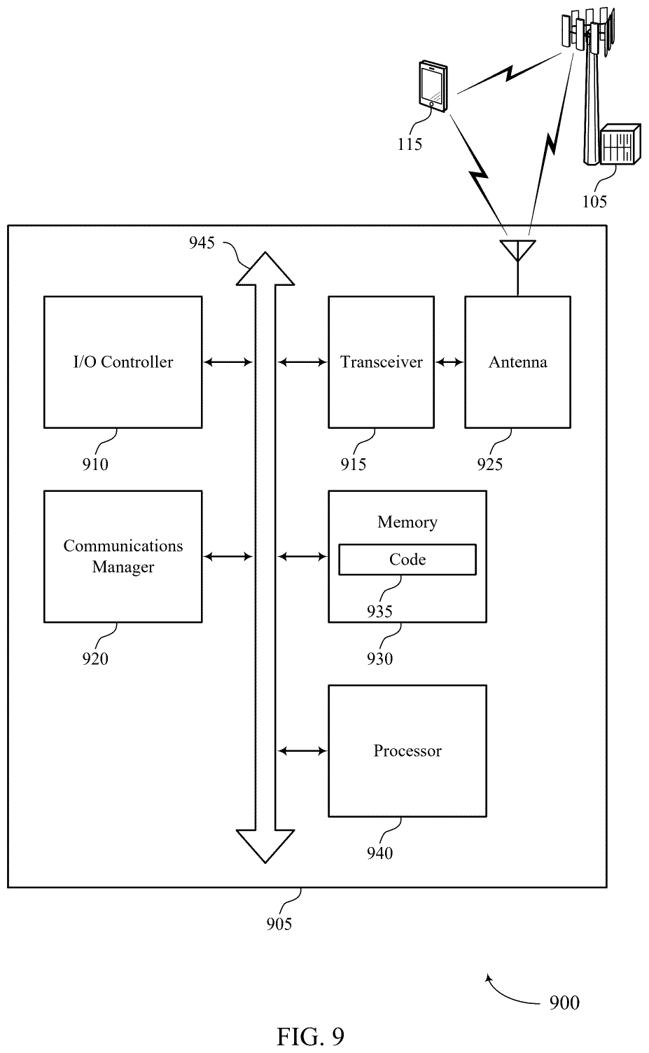

FIG. 9 shows a diagram of a system 900 including a device 905 that supports channel state information reporting in LP-WUS scenarios in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting channel state information reporting in LP-WUS scenarios). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling indicating a CSI reporting configuration, the CSI reporting configuration indicating a set of reporting occasions, where the set of reporting occasions includes a first reporting occasion scheduled for transmission of a CSI report. The communications manager 920 is capable of, configured to, or operable to support a means for selecting a second reporting occasion of the set of reporting occasions for transmission of the CSI report, the second reporting occasion occurring after the first reporting occasion and selected as a replacement to transmission of the CSI report via the first reporting occasion. The communications manager 920 is capable of, configured to, or operable to support a means for transmitting the CSI report via the second reporting occasion.

By including or configuring the communications manager 920 in accordance with examples as described herein, the device 905 may support techniques for transmission of CSI reports using reduced power consumption, such as when operating using LP-WUS techniques, which may improve the user experience via increased battery life and reduced processing and heat generation.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of channel state information reporting in LP-WUS scenarios as described herein, or the at least one processor 940 and the at least one memory 930 may be otherwise configured to, individually or collectively, perform or support such operations.

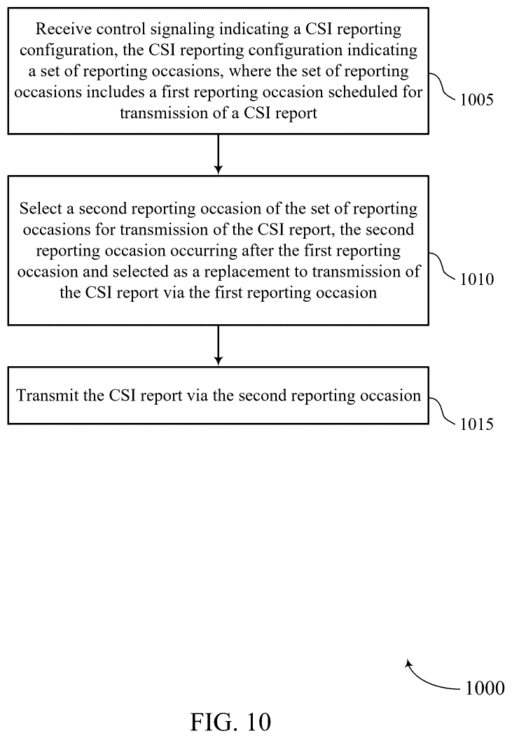

FIG. 10 shows a flowchart illustrating a method 1000 that supports channel state information reporting in LP-WUS scenarios in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control signaling indicating a CSI reporting configuration, the CSI reporting configuration indicating a set of reporting occasions, where the set of reporting occasions includes a first reporting occasion scheduled for transmission of a CSI report. The operations of 1005 may be performed in accordance with examples as disclosed herein. In some examples, aspects of the operations of 1005 may be performed by a configuration component 825 as described with reference to FIG. 8.

At 1010, the method may include selecting a second reporting occasion of the set of reporting occasions for transmission of the CSI report, the second reporting occasion occurring after the first reporting occasion and selected as a replacement to transmission of the CSI report via the first reporting occasion. The operations of 1010 may be performed in accordance with examples as disclosed herein. In some examples, aspects of the operations of 1010 may be performed by a reporting occasion component 830 as described with reference to FIG. 8.

At 1015, the method may include transmitting the CSI report via the second reporting occasion. The operations of 1015 may be performed in accordance with examples as disclosed herein. In some examples, aspects of the operations of 1015 may be performed by a CSI report component 835 as described with reference to FIG. 8.

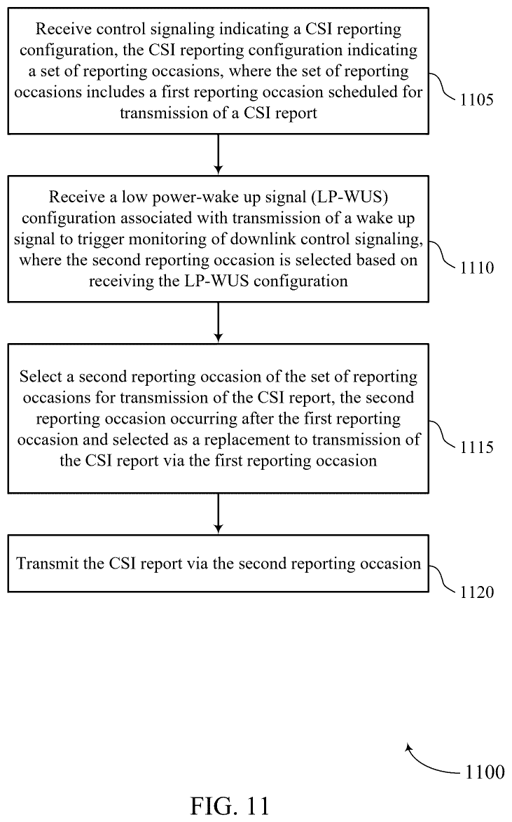

FIG. 11 shows a flowchart illustrating a method 1100 that supports channel state information reporting in LP-WUS scenarios in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating a CSI reporting configuration, the CSI reporting configuration indicating a set of reporting occasions, where the set of reporting occasions includes a first reporting occasion scheduled for transmission of a CSI report. The operations of 1105 may be performed in accordance with examples as disclosed herein. In some examples, aspects of the operations of 1105 may be performed by a configuration component 825 as described with reference to FIG. 8.

At 1110, the method may include receiving a low power-wake-up signal (LP-WUS) configuration associated with transmission of a wake-up signal to trigger monitoring of downlink control signaling, where the second reporting occasion is selected based on receiving the LP-WUS configuration. The operations of 1110 may be performed in accordance with examples as disclosed herein. In some examples, aspects of the operations of 1110 may be performed by a wake-up component 840 as described with reference to FIG. 8.

At 1115, the method may include selecting a second reporting occasion of the set of reporting occasions for transmission of the CSI report, the second reporting occasion occurring after the first reporting occasion and selected as a replacement to transmission of the CSI report via the first reporting occasion. The operations of 1115 may be performed in accordance with examples as disclosed herein. In some examples, aspects of the operations of 1115 may be performed by a reporting occasion component 830 as described with reference to FIG. 8.

At 1120, the method may include transmitting the CSI report via the second reporting occasion. The operations of 1120 may be performed in accordance with examples as disclosed herein. In some examples, aspects of the operations of 1120 may be performed by a CSI report component 835 as described with reference to FIG. 8.

The following provides an overview of aspects of the present disclosure:

Aspect 1: A method for wireless communications by a UE, comprising: receiving control signaling indicating a CSI reporting configuration, the CSI reporting configuration indicating a set of reporting occasions, wherein the set of reporting occasions comprises a first reporting occasion scheduled for transmission of a CSI report; selecting a second reporting occasion of the set of reporting occasions for transmission of the CSI report, the second reporting occasion occurring after the first reporting occasion and selected as a replacement to transmission of the CSI report via the first reporting occasion; and transmitting the CSI report via the second reporting occasion.

Aspect 2: The method of aspect 1, further comprising: receiving an LP-WUS configuration associated with transmission of a wake up signal to trigger monitoring of downlink control signaling, wherein the second reporting occasion is selected based at least in part on receiving the LP-WUS configuration.

Aspect 3: The method of aspect 2, wherein the set of reporting occasions is associated with a first reporting period, the method further comprising: selecting the second reporting occasion in accordance with a second reporting period that is longer than the first reporting period based at least in part on receiving the LP-WUS configuration.

Aspect 4: The method of any of aspects 2 through 3, further comprising: selecting the second reporting occasion based at least in part on one or more conditions failing to be satisfied.

Aspect 5: The method of aspect 4, wherein the one or more conditions comprise a reference signal received power associated with one or more beams indicated in a previous CSI report transmitted by the UE falling below a threshold value, a reference signal received power associated with a current beam of the UE falling below a threshold value, or both.

Aspect 6: The method of any of aspects 2 through 5, further comprising: receiving an indication of a subset of the set of reporting occasions for transmission of a respective CSI report, the subset comprising at least the second reporting occasion, wherein selecting the second reporting occasion is based at least in part on receiving the indication of the subset and the LP-WUS configuration.

Aspect 7: The method of aspect 6, wherein the subset of the set of reporting occasions comprises every other reporting occasion of the set of reporting occasions.

Aspect 8: The method of any of aspects 6 through 7, further comprising: transmitting a second CSI report via a third reporting occasion of the set of reporting occasions, the third reporting occasion absent from the subset, based at least in part on one or more conditions being satisfied.

Aspect 9: The method of aspect 8, wherein the one or more conditions comprise a reference signal received power associated with one or more beams indicated in a previous CSI report transmitted by the UE falling below a threshold value, a reference signal received power associated with a current beam of the UE falling below a threshold value, or both.

Aspect 10: The method of any of aspects 2 through 9, further comprising: receiving a wake up signal based at least in part on the received LP-WUS configuration; and selecting the second reporting occasion based at least in part on the second reporting occasion overlapping with an ON duration corresponding to the received wake up signal.

Aspect 11: The method of aspect 10, further comprising: receiving a reference signal after receiving the wake up signal and prior to the second reporting occasion, wherein transmitting the CSI report via the second reporting occasion is based at least in part on receiving the reference signal.

Aspect 12: The method of aspect 11, wherein transmitting the CSI report is based at least in part on receiving the reference signal at least a threshold duration prior to the second reporting occasion.

Aspect 13: The method of aspect 1, further comprising: selecting the second reporting occasion based at least in part on a reference signal received power associated with one or more beams indicated in a previous CSI report transmitted by the UE being above a threshold value, a reference signal received power associated with a current beam of the UE being above a threshold value, or both.

Aspect 14: The method of any of aspect 1 and 13, further comprising: receiving an indication of a subset of the set of reporting occasions for transmission of a respective CSI report, the subset comprising at least the second reporting occasion, wherein selecting the second reporting occasion is based at least in part on receiving the indication of the subset.

Aspect 15: The method of aspect 14, wherein the subset of the set of reporting occasions comprises every other reporting occasion of the set of reporting occasions.

Aspect 16: The method of any of aspects 14 through 15, further comprising: transmitting a second CSI report via a third reporting occasion of the set of reporting occasions, the third reporting occasion absent from the subset, based at least in part on one or more conditions being satisfied.

Aspect 17: The method of aspect 16, wherein the one or more conditions comprise a reference signal received power associated with one or more beams indicated in a previous CSI report transmitted by the UE falling below a threshold value, a reference signal received power associated with a current beam of the UE falling below a threshold value, or both.

Aspect 18: The method of any of aspects 1 and 13 through 17, wherein selecting the second reporting occasion is based at least in part on a reference signal being received at least a threshold duration prior to the second reporting occasion.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a channel state information (CSI) reporting configuration, the CSI reporting configuration indicating a set of reporting occasions, wherein the set of reporting occasions comprises a first reporting occasion scheduled for transmission of a CSI report;
select a second reporting occasion of the set of reporting occasions for transmission of the CSI report, the second reporting occasion occurring after the first reporting occasion and selected as a replacement to transmission of the CSI report via the first reporting occasion; and
transmit the CSI report via the second reporting occasion.

2. The UE of claim 1, wherein the second reporting occasion is selected for transmission of the CSI report based at least in part on being within an ON duration of a discontinuous reception (DRX) cycle.

3. The UE of claim 1, wherein the one or more processors are individually or collectively further operable to execute the code to cause the UE to:
select a subset of the set of reporting occasions for transmission of a respective CSI report, the subset comprising at least the second reporting occasion, wherein transmitting the CSI report via the second reporting occasion is based at least in part on selecting the subset.

4. The UE of claim 3, wherein the subset of the set of reporting occasions comprises a reduced frequency of reporting occasions with respect to the set of reporting occasions.

5. The UE of claim 3, wherein the subset of the set of reporting occasions comprises every other reporting occasion of the set of reporting occasions.

6. The UE of claim 3, wherein the one or more processors are individually or collectively further operable to execute the code to cause the UE to:
transmit a second CSI report via a third reporting occasion of the set of reporting occasions, the third reporting occasion absent from the subset, based at least in part on one or more conditions being satisfied.

7. The UE of claim 6, wherein the one or more conditions comprise a first reference signal received power associated with one or more beams indicated in a previous CSI report transmitted by the UE falling below a first threshold value, a second reference signal received power associated with a current beam of the UE falling below a second threshold value, or both.

8. The UE of claim 1, wherein selecting the second reporting occasion is based at least in part on a reference signal being received at least a threshold duration prior to the second reporting occasion.

9. The UE of claim 1, wherein the one or more processors are individually or collectively further operable to execute the code to cause the UE to:
receive a low power-wake up signal (LP-WUS) configuration associated with transmission of a wake up signal to trigger monitoring of downlink control signaling, wherein the second reporting occasion is selected based at least in part on receiving the LP-WUS configuration.

10. The UE of claim 9, wherein the one or more processors are individually or collectively further operable to execute the code to cause the UE to:
receive the wake up signal based at least in part on the received LP-WUS configuration; and
select the second reporting occasion based at least in part on the second reporting occasion overlapping with an ON duration corresponding to the received wake up signal.

11. The UE of claim 10, wherein the one or more processors are individually or collectively further operable to execute the code to cause the UE to:
receive a reference signal after receiving the wake up signal and prior to the second reporting occasion, wherein transmitting the CSI report via the second reporting occasion is based at least in part on receiving the reference signal.

12. The UE of claim 11, wherein transmitting the CSI report is based at least in part on receiving the reference signal at least a threshold duration prior to the second reporting occasion.

13. The UE of claim 9, wherein the set of reporting occasions is associated with a first reporting period, and the one or more processors are individually or collectively further operable to execute the code to cause the UE to:
select the second reporting occasion in accordance with a second reporting period that is longer than the first reporting period based at least in part on receiving the LP-WUS configuration.

14. The UE of claim 9, wherein the one or more processors are individually or collectively further operable to execute the code to cause the UE to:
select the second reporting occasion based at least in part on one or more conditions failing to be satisfied.

15. The UE of claim 14, wherein the one or more conditions comprise a first reference signal received power associated with one or more beams indicated in a previous CSI report transmitted by the UE falling below a first threshold value, a second reference signal received power associated with a current beam of the UE falling below a second threshold value, or both.

16. The UE of claim 9, wherein the one or more processors are individually or collectively further operable to execute the code to cause the UE to:
select a subset of the set of reporting occasions for transmission of a respective CSI report, the subset comprising at least the second reporting occasion, wherein transmitting the CSI report via the second reporting occasion is based at least in part on selecting the subset.

17. The UE of claim 16, wherein the subset of the set of reporting occasions comprises every other reporting occasion of the set of reporting occasions.

18. The UE of claim 16, wherein the one or more processors are individually or collectively further operable to execute the code to cause the UE to:
transmit a second CSI report via a third reporting occasion of the set of reporting occasions, the third reporting occasion absent from the subset, based at least in part on one or more conditions being satisfied.

19. A method for wireless communications by a user equipment (UE), comprising:
receiving control signaling indicating a channel state information (CSI) reporting configuration, the CSI reporting configuration indicating a set of reporting occasions, wherein the set of reporting occasions comprises a first reporting occasion scheduled for transmission of a CSI report;
selecting a second reporting occasion of the set of reporting occasions for transmission of the CSI report, the second reporting occasion occurring after the first reporting occasion and selected as a replacement to transmission of the CSI report via the first reporting occasion; and
transmitting the CSI report via the second reporting occasion.

20. A non-transitory computer-readable medium storing code for wireless communications, the code comprising instructions executable by one or more processors to:
receive control signaling indicating a channel state information (CSI) reporting configuration, the CSI reporting configuration indicating a set of reporting occasions, wherein the set of reporting occasions comprises a first reporting occasion scheduled for transmission of a CSI report;
select a second reporting occasion of the set of reporting occasions for transmission of the CSI report, the second reporting occasion occurring after the first reporting occasion and selected as a replacement to transmission of the CSI report via the first reporting occasion; and
transmit the CSI report via the second reporting occasion.
